(19) United States
(12) Patent Application Publication
(10) Pub. No.: US 2005/0226200 A1
(43) Pub. Date: Oct. 13, 2005

(54) A Power Line Communication System that Enables Low-Cost Last Mile Access to any Legacy or Emerging Network Infrastructure

(75) Inventors: Bernt Askild Askildsen, Rapid City, SD (US); Scott Randall Thompson, Hermosa, SD (US)

Correspondence Address: Scott Thompson;RealTronics Corporation/EdgeCOM, 322 Canal Street, Rapid City, SD, 57701-2680, US

(73) Assignee: EDGECOM, Rapid City, SD (US)

(21) Appl. No.: 10/907,187

(22) Filed: Mar. 23, 2005

Related U.S. Application Data
(60) Provisional application No. 60/556,834, filed on Mar. 26, 2004.

(51) Int. Cl. H04M 11/00; H04B 7/212

(52) U.S. Cl. 370/347; 379/90.01

(57) ABSTRACT

An economically attractive method to provide multiuse broadband connectivity to the edge of legacy telecommunication and emerging networks is disclosed. The invention utilizes a multi-phase common signal return coupling scheme that passes signals onto the step-down side of power transformers. This invention enables the transformer to serve as an economically attractive distribution point that transfers external payload signals from service providers to customer network access points on the load side of the transformer. The resulting power line network will permit remote control of utilization and access to any legacy or emerging network payload such as ITU and IETF that is present at any type of electric power transformer.

### CROSS-REFERENCE TO RELATED APPLICATIONS

Current US Class: 379/142.14, 455/402, 3.01

Intern'l Class: H01F 027/42

Field of Search: 200/49, 307/3, 340/310.01, 310.05, 310.07, 370/276, 375/145, 379/142.14, 23, 455/3.01, 3.05, 14, 74.1, 280, 402, 560, 572

### STATEMENT REGARDING FEDERALLY SPONSORED RESEARCH OR DEVELOPMENT

None

### REFERENCE TO SEQUENCE LISTING, A TABLE, OR A COMPUTER PROGRAM APPENDIX

None

### BACKGROUND OF THE INVENTION

This invention addresses the quest of competitive local exchange carriers and other emerging network operators to gain direct access to potential customers without paying extensive access charges to companies that own incumbent infrastructures. The invention provides a low-cost solution that enables communication service providers that are competing in these new markets to bypass physical communication lines that are owned by entrenched competitors.

Power line communications (PLC) dates back to the 1940's when important aspects about the technology were first disclosed in U.S. Pat. Nos. 2,510,273 and 2,516,211; both issued in 1950. Since that time 154 U.S. and 19 foreign patents were registered with claims to protect improvements and alternative approaches to power line communications. However, none of these patents address the opportunity to reduce the market entry startup costs and performance barriers that have impeded widespread acceptance of PLC technologies. A comprehensive reference list of these patents is disclosed in U.S. Pat. No. 6,243,571, which is hereby incorporated by reference in its entirety for the material disclosed therein. Other more recent expired patents in the PLC arena include U.S. Pat. No. 3,949,72, “Telephone Extension”; U.S. Pat. Nos. 4,636,771 and 4,745,391 “Data Communications”; U.S. Pat. No. 4,473,817, “Single Phase Signal Coupling”; and U.S. Pat. No. 4,458,236, “Three Phase Signal Coupling”. These expired patents provide a broad foundation of expired prior art that launched the use of power lines as a physical layer for communication applications.

The below listed relevant recent prior art suffers from high cost, low data transfer rates, installation difficulties, limited access to roof tops and landlord permissions, high distribution costs, applicability, performance and any combination of the foregoing: U.S. Pat. No. 5,559,377, “Transformer Coupler for Communication Over Various Lines”; U.S. Pat. No. 6,107,912, “Wireless Modem Jack”; U.S. Pat. No. 6,243,571, “Method and System for Distribution of Wireless Signals for Increased Wireless Coverage Using Power Lines”; U.S. Pat. No. 6,246,868, “Conversion and Distribution of Incoming Wireless Telephone Signals Using the Power Line”; U.S. Pat. No. 6,487,657, “Data Communication Network”; U.S. Pat. No. 6,573,826, “Wireless Communication System by Using Electric Power Line as Data Link Network”; U.S. Pat. No. 677,522, “Concurrent Wireless/Landline Interface Apparatus and Method”; and, U.S. Pat. No. 6,785,532, “Power Line Communications”.

Prior art fails to describe, in particular, a solution that affords last mile broadband and voice service that is economically attractive for competitive local exchange carriers and those who seek to bypass existing telecommunication and emerging networks. This invention fills the void and the deficiencies of prior art that were cited in the preceding paragraph by enabling optimal selection of back haul access techniques and line-of-sight reduction while providing a nearly identical and repeatable installation method that yields access to a price regulated domain for installation of the technology. This invention further addresses performance deficiencies of prior art by using the transformer as a distribution point (D-point), by eliminating the need for ad-hoc phase signal couplers, and by providing a means to remotely control bandwidth access and utilization for each customer network access point.

### BRIEF SUMMARY OF THE INVENTION

This invention discloses a method of coupling payload signals from communication service providers to the secondary, or load side, of existing power line transformers. An intention of this invention is to use power lines emanating from step-down transformers as a distribution point (D-point) to provide a low-cost way to bypass any existing physical connection to the edge of any type of communication network. The invention utilizes a multi-phase galvanic isolating coupling scheme that passes signals onto the secondary side of step-down power transformers to simultaneously protect energy customers from lightning effects while ensuring signal presence in all phases on the end-user side of the power meter. This invention uses the common neutral power line at the transformer as a signal return path, which eliminates the need for signal couplers between active phases. Customer network access points, including those disclosed in patent application Ser. No. 10/906,864, receive these signals and translate them into standard legacy and emerging network termination points that support any International Telecommunication Union (ITU), Internet Engineering Task Force (IETF) and any computer interface standards. The invention will provide a means for remote or direct network management functions including but not limited to bandwidth access and utilization control, quality of service and security.

### BRIEF DESCRIPTION OF THE SEVERAL VIEWS OF THE DRAWING

The below listed figures use drawings of two-phase and three-phase images to illustrate the disclosed invention. These drawings do not limit the scope of this invention to two-phase and three-phase systems. This invention disclosure describes a device that is intended for use on any single or multiple phase power line network on the load side of any power transformer.

FIG. 1: Is an illustration of the concept of a power pole transformer distribution point.

FIG. 2: Is an illustration of a typical transformer based distribution point assembly

FIG. 3: Is an illustration of multi phase coupling to ensure signal presence on any power phase on the load side of a transformer.

FIG. 4: Is an illustration of a signal feedback loop over a common neutral line.

FIG. 5: Is an illustration of how the distribution point may be implemented.

FIG. 6: Is an illustration of how a network access point may be implemented.

### DETAILED DESCRIPTION OF THE INVENTION

This invention disclosure describes the application of any device that couples communication signals from alternative communication media to power lines for the purpose of bypassing existing physical communication lines between the curb and the customer network access point. It is not the intention of this invention to disclose power line communication devices that for the most part are disclosed by prior art. The intention of this invention is to provide a low-cost means to install any combination of legacy or emerging network connectivity to the load side of any power transformer. The novelty of the approach disclosed herein is the application of any type of power line communication device at or near the power transformer, which enables easy installation, low-cost access to a price regulated domain, and assured signal presence on every power line phase on the load side of the transformer. This disclosure includes a unique method of signal coupling that uses a common conductor, usually neutral or ground, as a signal feedback loop. The invention works on pole mount, ground mount, and any other type of power transformers.

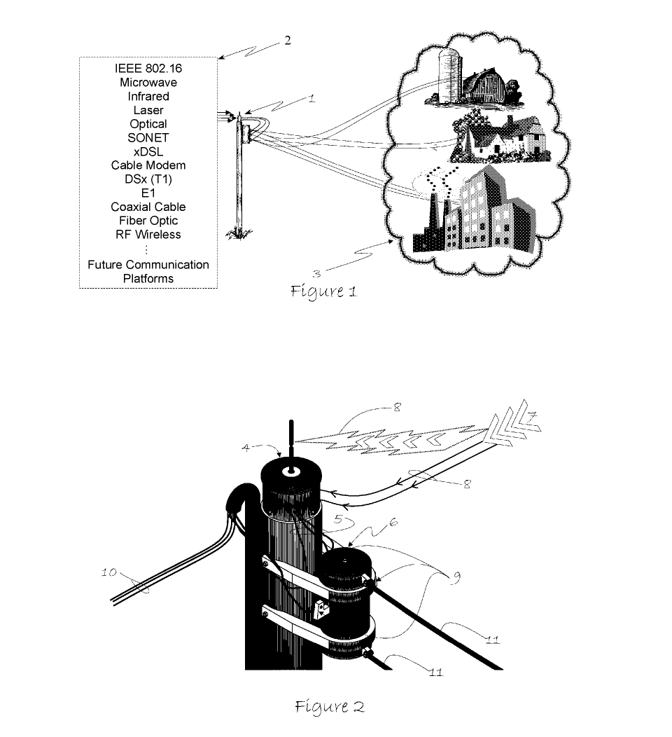

The general application of the disclosed invention is illustrated in FIG. 1. The invention comprises a device 1 at or near the power transformer that couples legacy or emerging network payload signals from wired or wireless communication protocols including but not limited to the types listed in 2 to the load side of a power transformer. The distribution point formed by this invention subsequently provides controllable access to any type of electric energy customer including but not limited to those shown by example at 3. A closer inspection of the disclosed invention, shown by example as a pole-mounted distribution point (D-Point) 4 in FIG. 2, illustrates how the device is physically connected through signal coupling wires 5 to the load side of the power line transformer 6. The D-Point 4 can be any device that couples communication protocols 7 to power lines and accepts input from any wired or wireless physical layer 8 that contains any type of payload signal that may include but is not limited to the types shown by example at 1. These signals are connected to the load side of the transformer at 9 via the coupling wires at 5 and subsequently delivered to the end-user over the existing power lines 10. The power line communication device bypasses and hence isolates any communication signals at 9 from lightning and other surges that are present at the grid wires 11 on the primary side of the transformer.

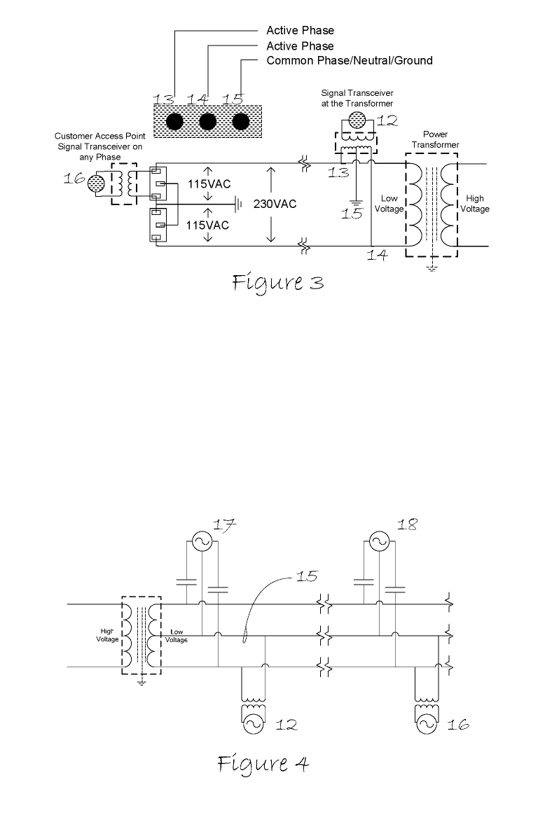

A detailed schematic that illustrates how and where the disclosed invention couples payload signals to all power lines on all phases on the load side of the transformer is shown in FIG. 3. This example illustrates how to assemble and mount a power line communication bridge for a two phase system, however, a similar schematic, connection, and assembly approach can be used to extend the scope of the invention to any single or multiple phase power line system on the load side of any transformer. The proposed invention functions optimally by connecting any device that bridges signals to power lines, shown by example at 12, directly to all of the active lines on the load side of the transformer, shown by example at 13 and 14, and a by connecting the signal reference of the communication bridge to the common, neutral, or ground power line at 15. This approach ensures signal presence for any customer access point, shown by example at 16, on all active phases in the power line network on the load side of the transformer. Inductive signal transceivers are shown at 15 and 16 to illustrate placement of any type of reactive signal coupler near the transformer and does not restrict the scope of this invention to the use of inductive signal couplers. The use of capacitive and inductive signal couplers is illustrated in the schematic shown in FIG. 4. This drawing provides an example of multiple signal coupling at the transformer and the use of multiple customer access points and on the load side of the transformer. The common signal reference path 15 and the inductive signal transceivers at the transformer 12 and at the customer access points 16 are displayed in FIG. 4 with similar capacitive transceivers at the transformer 17 and at the customer access points 18 to illustrate the capacity of this invention to simultaneously accommodate multiple types of signal transceivers across the power line network.

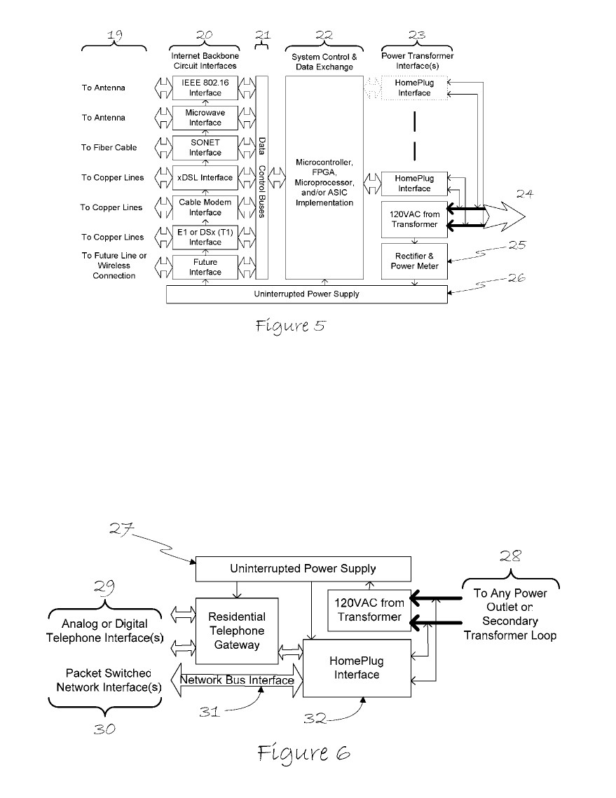

A detailed block diagram that illustrates how to assemble the communication bridge component (D-Point) of this invention, which is used to deliver signals from external service providers or any other type of signals to the previously elucidated signal transceivers at 12, 16, 17, and 18, is shown in FIG. 5. The components shown in FIG. 5 and the transformer based signal transceivers at 12 and 17 comprise the power line network distribution point module of this invention. Any or all of the features that are shown in the block diagram in FIG. 5 may be present or absent to suit the distribution point needs of any given power line network. The block diagrams in FIG. 5 and FIG. 6 are for illustration purposes only and do not limit the power line interface to any particular standard like HomePlug.

The communication bridge in FIG. 5 is a device that accepts radio frequency (RF) signals and those that are present on fiber optic, coaxial cable, copper wire, and any other form of communication media including but not limited to those listed at 19. The communication bridge converts these signals, which may be in any format including but not limited to the legacy circuit interfaces listed at 20 into a format that can be distributed over power lines. The communication bridge is controlled by a system control and data exchange processor 22 that can be a Microcontroller, Field Programmable Gate Arrays (FPGA), Microprocessor, Application-Specific Integrated Circuit (ASIC) or any other type of control logic based architecture. The control architecture 22 processes signals that are presented to the data and control bus at 21, transforms these data into a power line communication format, and controls data processing at the power transformer physical layer 23 to ensure reliable communications between the D-Point and any number of HomePlug or other standard of customer access points on the power line network. The signals from 23 are supplied to the power line transceivers at 12 and 17 through the transformer shown at 25. The communication bridge may also include an integrated power meter 25 to document energy consumption. To ensure system uptime and life line support for telephone communications, an uninterrupted power supply 26 can be integrated into the D-Point. This component enables continuous customer access to telephone and/or Internet connectivity during a power outage.

FIG. 6 displays a typical customer network access point (NAP) on the power line based network. The previously described D-Point communicates with one or multiple NAP's that can be located anywhere on the load side of the transformer. This and the fact that the signals from most power line communication network platforms can pass through power meters is a particularly important cost saving benefit for urban areas where 8 or more residential customers may be supported by one transformer. Another notable component in FIG. 6 is the lifeline support battery at 27, which is disclosed in patent application Ser. No. 10/906,864 and enables continuous operation of individual access point units anywhere on power line network 28. The customer access point block diagram shown in FIG. 6 uses a standard network bus interface 30 to deliver interface standards 31 including but not limited to packet switched platforms such as Ethernet TCP/IP over any power line network interface standard including but not limited to the HomePlug interface shown at 32. Select network access points also support connectivity to conventional analog and/or digital telephone interfaces 29 and other ITU, IETF, and standard computer interfaces.

A completely assembled system as described by this invention disclosure offers optimal selection of back haul access points, mitigation of the need of line-of-sight, and provides a repeatable installation method for all customers, and access to a price regulated domain for installation and utilization of the technology. One application of the combined distribution point and customer access point model described herein is to bridge communications between the Institute of Electrical and Electronics Engineers (IEEE) 802.16 communication standard and the HomePlug standard. This sample application of the disclosed invention will reduce rollout costs and setup time and lower the cost per user threshold in part by capitalizing on the guaranteed line of sight between power poles and the net optimization increase of shared bandwidth. This example is not intended to limit the scope of this invention as this invention is intended to couple any existing and future communication media to the load side of any power transformer.

1. Any device of the type shown by example in the attached drawings that acts as a signal payload distribution point that couples any type of communication or multi-media signals from any source directly to the step-down side of any type of power transformer without passing signals through the power transformer and without forming a physical connection between the primary and secondary side of the transformer that includes in combination,
a. Any device that couples signals to multiple phases on the secondary side of the transformer;
b. Any device that enables the power line physical layer to pass signals through the power meter to reach any customer network access point;
c. Any device that couples data from RF signals to directly to power lines on the secondary side of the transformer;
d. Any device that couples data from infrared signals to directly to power lines on the secondary side of the transformer;
e. Any device that couples data from laser signals to directly to power lines on the secondary side of the transformer;
f. Any device that couples data from optical signals to directly to power lines on the secondary side of the transformer;
g. Any device that couples data from coaxial cable signals to directly to power lines on the secondary side of the transformer;
h. Any device that couples data from fiber-optic cable signals to directly to power lines on the secondary side of the transformer;
i. Any device that couples data from any future communication source directly to power lines on the secondary side of the transformer.

2. Any device of the type in claim 1 that uses any power line on the secondary side of the transformer as a signal return path that includes in combination,
a. any device that uses neutral or common ground as a signal return path;
b. any device that uses any phase as a signal return path.

3. Any device that converts any signals that are coupled to the secondary side of the transformer from any device of the type in claim 1 to any usable network access point format that includes in combination,
a. Any device that converts signals that are present on power lines to a useable format for computers;
b. Any device that converts signals that are present on power lines to a useable format for televisions;
c. Any device that converts signals that are present on power lines to a useable format for telephones;
d. Any device that converts signals that are present on power lines to a useable format for multi-media platforms.

4. Any device of the type in claim 2 that provides a method of controlling access to signals on power lines that have been coupled to the secondary side of the transformer from any device of the type in claim 1 that includes in combination,
(a) Any multi-user hardware and software exchange modules, located anywhere on the secondary side of the transformer that controls bandwidth utilization, quality of service, and network management functions;
(b) Any device that converts signals that are present on power lines to a useable format for any combination of items of the type in claim 3.

5. Any combination of devices of the types in claim 1, claim 2, claim 3, and claim 4 that bridge communications between any type of power line network architecture and any type of external architecture that includes in combination,
(a) Any combination of devices that bridges communications between any type of power line network architecture and the internet;
(b) Any combination of devices that bridges communications between any type of power line network architecture and any external voice communication service;
(c) Any combination of devices that bridges communications between any type of power line network architecture and any external data communication service;
(d) Any combination of devices that bridges communications between any type of power line network architecture and any external multi-media service;
(e) Any combination of devices that bridges communications between any type of power line network architecture and an external control device;
(f) Any combination of devices that bridges communications between any type of power line network architecture and an external monitoring device;
(g) Any combination of devices that enables any power line communication system anywhere on the secondary side of the transformer to access any external communication service.

6. Any device of the type in claim 1, claim 2, claim 3, claim 4, and claim 5 that ensures that communication signals are present on any number of phases on the secondary side of the transformer of a power line system that includes in combination,
(a) Any ungrounded power line system;
(b) Any ground power line system;
(c) Any single phase power line system;
(d) Any two-phase power line system;
(e) Any three-phase power line system;
(f) Any multiple phase power line system;
(g) Any multiple transformer power line system.

7. Any device of the type in claim 1, claim 2, claim 3, claim 4, claim 5, and claim 6 that includes a power meter or other device that is able to record and report the amount of energy that is consumed by the device.

8. Any device of the type in claim 1, claim 2, claim 3, claim 4, claim 5, and claim 6 that includes a battery or any form of uninterruptible power supply to ensure continuous device operation in the absence of power from the transformer or any other source of conventional electric power.
